(19) United States
(12) Patent Application Publication
(10) Pub. No.: US 2015/0114640 A1
(43) Pub. Date: Apr. 30, 2015

(54) PROPPANTS WITH IMPROVED STRENGTH

(71) Applicant: Baker Hughes Incorporated, Houston, TX (US)

(72) Inventors: NAIMA BESTAOUI-SPURR, The Woodlands, TX (US); QI QU, Spring, TX (US); CHRISTOPHER J. STEPHENSON, Houston, TX (US)

(73) Assignee: Baker Hughes Incorporated, Houston, TX (US)

(21) Appl. No.: 14/066,893

(22) Filed: Oct. 30, 2013

(51) Int. Cl. C09K 8/80; E21B 43/267

(52) U.S. Cl. CPC C09K 8/805; E21B 43/267
USPC 166/280.2; 507/269; 507/204; 507/219; 507/274; 507/271; 427/212; 427/215

(57) ABSTRACT

Cements, such as alkali activated aluminosilicate, may be used as coatings on proppants, such as brown sand and white sand, to improve the strength thereof. The resulting coated proppants show increased strength as well as produced fines of lower than about 10 wt % at 10,000 psi closure stress.

### TECHNICAL FIELD

The present invention relates to proppants used in hydraulic fracturing treatments for subterranean formations, and more particularly relates to methods for making proppants and proppants made thereby where the proppants have a coating that imparts improved strength.

### TECHNICAL BACKGROUND

Hydraulic fracturing is a common stimulation technique used to enhance production of hydrocarbon fluids from subterranean formations. In a typical hydraulic fracturing treatment, fracturing treatment fluid containing a solid proppant material is injected into the formation at a pressure sufficiently high enough to cause the formation to fracture or cause enlargement of natural fractures in the reservoir. The fracturing fluid that contains the proppant or propping agent typically has its viscosity increased by a gelling agent such as a polymer, which may be uncrosslinked or crosslinked, and/or a viscoelastic surfactant. During a typical fracturing treatment, propping agents or proppant materials are deposited in a fracture, where they remain after the treatment is completed. After deposition, the proppant materials serve to hold the fracture open, thereby enhancing the ability of fluids to migrate from the formation to the well bore through the fracture. Because fractured well productivity depends on the ability of a fracture to conduct fluids from a formation to a wellbore, fracture conductivity is an important parameter in determining the degree of success of a hydraulic fracturing treatment and the choice of proppant may be critical to the success of stimulation.

One problem related to hydraulic fracturing treatments is the creation of reservoir “fines” and associated reduction in fracture conductivity. These fines may be produced when proppant materials are subjected to reservoir closure stresses within a formation fracture which cause proppant materials to be compressed together in such a way that small particles (“fines”) are generated from the proppant material and/or reservoir matrix. In some cases, production of fines may be exacerbated during production/workover operations when a well is shut-in and then opened up. This phenomenon is known as “stress cycling” and is believed to result from increased differential pressure and closure stress that occurs during fluid production following a shut-in period. Production of fines is undesirable because of particulate production problems, and because of reduction in reservoir permeability due to plugging of pore throats in the reservoir matrix.

Production of particulate solids with subterranean formation fluids is also a common problem. The source of these particulate solids may be unconsolidated material from the formation, proppant from a fracturing treatment and/or fines generated from crushed fracture proppant, as mentioned above. Production of solid proppant material is commonly known as “proppant flowback.” In addition to causing increased wear on downhole and surface production equipment, the presence of particulate materials in production fluids may also lead to significant expense and production downtime associated with removing these materials from wellbores and/or production equipment. Accumulation of these materials in a well bore may also restrict or even prevent fluid production. In addition, loss of proppant due to proppant flowback may also reduce conductivity of a fracture pack.

It will be appreciated that if proppant strength can be improved that at least two problems are addressed. First, proppants with improved strength can better hold the fracture open to facilitate the production of hydrocarbon fluids. Second, stronger proppants do not disintegrate and exacerbate the production of fines. Thus, it would be very desirable to discover methods to produce stronger proppants.

### SUMMARY

There is provided, in one non-limiting form, coated proppants which include a plurality of proppant cores selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof; and a coating at least partially covering the proppant cores, where the coating is selected from the group consisting of aluminosilicate, magnesium phosphate, aluminum phosphate, zirconium aluminum phosphate, zirconium phosphate, zirconium phosphonate, polymer cements, high performance polymer coating such as polyamide imide and polyether ether ketones (PEEK), and combinations thereof.

Additionally there is provided in a non-restrictive embodiment a method of preparing a strengthened proppant involving mixing together an alkali metal hydroxide and an aluminosilicate binder in water to form an aqueous solution, coating a plurality of proppant cores with the aqueous solution, and heating the solution-coated proppant cores to polymerize the aluminosilicate.

Further there are provided coated proppants in one non-limiting embodiment prepared by a method involving mixing together an alkali metal hydroxide and an aluminosilicate binder to form an aqueous solution, coating a plurality of proppant cores with the aqueous solution, and heating the solution-coated proppant cores to polymerize the aluminosilicate.

There is additionally provided in a different non-restrictive version a method for controlling fines production from a subterranean formation, which method involves placing at least one wellbore in the formation and hydraulically fracturing the formation via the wellbore via a fracturing fluid which creates at least one fracture. The method further includes placing coated proppants into the fracture, where the coated proppants include a plurality of proppant cores selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof and a coating at least partially covering the proppant cores, where the coating is selected from the group consisting of aluminosilicate, magnesium phosphate, aluminum phosphate, zirconium aluminum phosphate, zirconium phosphate, zirconium phosphonate, magnesium potassium phosphate, carbide materials such as tungsten carbide, polymer cements, high performance polymer coatings such as polyamide-imide and polyether ether ketones (PEEK), and combinations thereof, where the coating ranges from about 2 wt % to about 30 wt % of the proppant cores. The method additionally includes removing the fracturing fluid from at least one fracture, where the closure stress of the fracture ranges from about 5000 to about 12,000 psi. Finally the method includes producing a fluid from the formation where the fines obtained are lower than about 10 wt % at stress.

### BRIEF DESCRIPTION OF THE DRAWINGS

The following descriptions should not be considered limiting in any way.

FIG. 1 is a schematic cross-section illustration of a coated proppant as described herein;

FIG. 2A is a microphotograph of white sand proppant with a 5 wt % coating of an alkali activated aluminosilicate;

FIG. 2B is a microphotograph of the white sand proppant used to form the coated proppant shown in FIG. 2A;

FIGS. 3A-3D are scanning electron microscopy (SEM) images of the coated white sand proppants of FIG. 2 at 50× magnification;

FIGS. 4A-4D are scanning electron microscopy (SEM) images of the coated white sand proppants of FIG. 2 at 80× magnification;

FIG. 5A is a microphotograph of brown sand proppant with a 8 wt % coating of an alkali activated aluminosilicate;

FIG. 5B is a microphotograph of the brown sand proppant used to form the coated proppant in FIG. 5A;

FIG. 6 is a microphotograph of brown sand proppant with a 15 wt % coating of an alkali activated aluminosilicate; and

FIG. 7 is a graph illustrating the wt % generated fines as a function of closure stress of geopolymer-coated sand compared to some conventional proppants.

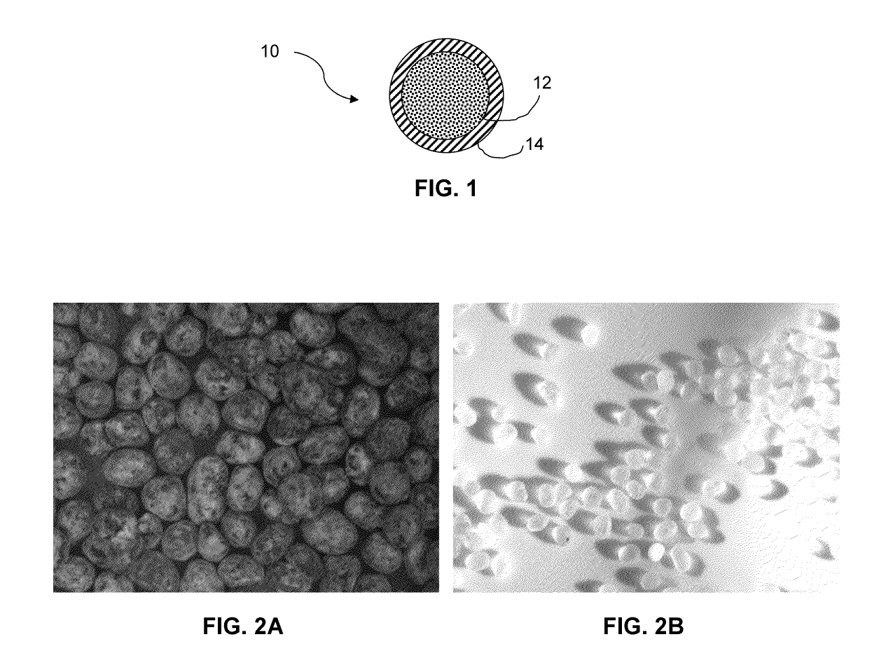

It will be appreciated that FIG. 1 is a schematic illustration, and that it is not necessarily to scale, and that certain proportions and features may be exaggerated for clarity. For instance, the proppant shown in FIG. 1 is illustrated to be perfectly spherical, whereas the microphotographs of FIGS. 2A-6 show that the proppants are actually only approximately spherical.

### DETAILED DESCRIPTION

It has been discovered that alkali activated aluminosilicate and other materials may be used as coatings in order to improve the strength of proppants, including, but not necessarily limited to, brown and white sand. The resulting coated proppant material show a dramatic improvement in the strength of both the white and brown sand. In both cases, the fines flowback obtained at a 10,000 psi (69 MPa) closure stress using the API standards are lower than about 10 wt %.

More specifically, a method and composition is described to coat proppant sand to dramatically increase its strength thereby extending its usage to formation closing stresses to at least about 5000 (34 MPa), alternatively at least to about 10,000 (69 MPa) and in another non-limiting embodiment to about 12,000 psi (83 MPa). By “withstanding” closure stresses in this range is meant that the coated proppant will not be crushed or disintegrated at these closure stresses.

The coated proppant is slightly lighter than sand and its apparent density is expected to range between about 2.3 independently to about 2.63 g/cm³, alternatively from between about 2.55 independently to about 2.6 g/cm³. The term “independently” as used herein with respect to a parameter range means that any lower threshold may be combined with any upper threshold to provide a suitable, acceptable alternative range.

Inorganic polymers are used as coating materials by mixing an alkali metal hydroxide/silicate solution and aluminosilicate binder which results in a very strong, rigid network. The resulting coatings have an amorphous, three dimensional structure similar to that of an aluminosilicate glass. The polymerization is thermally triggered to form a solid polymer at mild heat causing silicon and aluminum hydroxide molecules to poly-condense or polymerize, forming rigid chains or nets of oxygen bonded tetrahedra. The physical properties of the resultant rigid chain or net of geopolymer are largely determined by the ratio of silica and aluminum in the geopolymer. By varying this ratio, the material may be made rigid, suitable for use as a concrete, cement, or waste encapsulating medium, or more flexible for use as an adhesive, sealant or as an impregnating resin. The coating process is similar to that of resin coated sand and is accomplished by coating heated sand in a mixer, such as a rotary mixer, with the metal hydroxide/silicate solution then adding the aluminosilicate binder when exposing the sample to a heat gun or other heat source for less than about ten minutes to trigger polymerization. The resulting proppant may or not then be put in an oven for about three hours to finish the polymerization process, if necessary.

In one non-limiting embodiment, the proppants, sometimes called proppant cores, may include, but not necessarily be limited to, white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof.

Examples of ceramics include, but are not necessarily limited to, oxide-based ceramics, nitride-based ceramics, carbide-based ceramics, boride-based ceramics, silicide-based ceramics, or a combination thereof. In a non-limiting embodiment, the oxide-based ceramic may include, but is not necessarily limited to, silica (SiO₂), titania (TiO₂), aluminum oxide, boron oxide, potassium oxide, zirconium oxide, magnesium oxide, calcium oxide, lithium oxide, phosphorous oxide, and/or titanium oxide, or a combination thereof. The oxide-based ceramic, nitride-based ceramic, carbide-based ceramic, boride-based ceramic, or silicide-based ceramic may contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like). Exemplary ceramics include, but are not necessarily limited to, zirconia, stabilized zirconia, mullite, zirconia toughened alumina, spinel, aluminosilicates (e.g., mullite, cordierite), perovskite, silicon carbide, silicon nitride, titanium carbide, titanium nitride, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, and the like, or a combination thereof.

Examples of suitable sands for the proppant core include, but are not limited to, Arizona sand, Wisconsin sand, Badger sand, Brady sand, and Ottawa sand. In a non-limiting embodiment, the solid particulate may be made of a mineral such as bauxite are sintered to obtain a hard material. In another non-restrictive embodiment, the bauxite or sintered bauxite has a relatively high permeability such as the bauxite material disclosed in U.S. Pat. No. 4,713,203, the content of which is incorporated by reference herein in its entirety.

In another non-limiting embodiment, the proppant core may be a relatively lightweight or substantially neutrally buoyant particulate material or a mixture thereof. Such materials may be chipped, ground, crushed, or otherwise processed. By “relatively lightweight” it is meant that the solid particulate has an apparent specific gravity (ASG) which is less than or equal to 2.45, including those ultra lightweight materials having an ASG less than or equal to 2.25, alternatively less than or equal to 2.0, in a different non-limiting embodiment less than or equal to 1.75, and in another non-restrictive version less than or equal to 1.25 and often less than or equal to 1.05.

Naturally occurring solid particulates include, but are not necessarily limited to, nut shells such as walnut, coconut, pecan, almond, ivory nut, brazil nut, and the like; seed shells of fruits such as plum, olive, peach, cherry, apricot, and the like; seed shells of other plants such as maize (e.g., corn cobs or corn kernels); wood materials such as those derived from oak, hickory, walnut, poplar, mahogany, and the like. Such materials are particles may be formed by crushing, grinding, cutting, chipping, and the like.

Suitable relatively lightweight solid particulates are those disclosed in U.S. Pat. Nos. 6,364,018, 6,330,916 and 6,059,034, all of which are herein incorporated by reference in their entirety.

Other solid particulates for use herein include beads or pellets of nylon, polystyrene, polystyrene divinyl benzene or polyethylene terephthalate such as those set forth in U.S. Pat. No. 7,931,087, also incorporated herein by reference in its entirety.

Fracture proppant sizes may be any size suitable for use in a fracturing treatment of a subterranean formation. It is believed that the optimal size of particulate material relative to fracture proppant material may depend, among other things, on in situ closure stress. For example, a fracture proppant material may be desirable to withstand a closure stress of at least about 1000 psi (6.9 MPa), alternatively of at least about 5000 psi (34 MPa) or greater, up to 10,000 psi (69 MPa), even without the coating. However, it will be understood with benefit of this disclosure that these are just optional guidelines. In one embodiment, the proppants used in the disclosed method may have a beaded shape or spherical shape and a size of from about 4 mesh independently to about 100 mesh, alternatively from about 8 mesh independently to about 60 mesh, alternatively from about 12 mesh independently to about 50 mesh, alternatively from about 16 mesh independently to about 40 mesh, and alternatively about 20/40 mesh. Thus, in one embodiment, the proppants may range in size from about 1 or 2 mm independently to about 0.1 mm; alternatively their size will be from about 0.2 mm independently to about 0.8 mm, alternatively from about 0.4 mm independently to about 0.6 mm, and alternatively about 0.6 mm. However, sizes greater than about 2 mm and less than about 0.1 mm are possible as well.

Suitable shapes for proppants include, but are not necessarily limited to, beaded, cubic, bar-shaped, cylindrical, or a mixture thereof. Shapes of the proppants may vary, but in one embodiment may be utilized in shapes having maximum length-based aspect ratio values, in one exemplary embodiment having a maximum length-based aspect ratio of less than or equal to about 25, alternatively of less than or equal to about 20, alternatively of less than or equal to about 7, and further alternatively of less than or equal to about 5. In yet another exemplary embodiment, shapes of such proppants may have maximum length-based aspect ratio values of from about 1 independently to about 25, alternatively from about 1 independently to about 20, alternatively from about 1 independently to about 7, and further alternatively from about 1 independently to about 5. In yet another exemplary embodiment, such proppants may be utilized in which the average maximum length-based aspect ratio of particles present in a sample or mixture containing only such particles ranges from about 1 independently to about 25, alternatively from about 1 independently to about 20, alternatively from about 2 independently to about 15, alternatively from about 2 independently to about 9, alternatively from about 4 independently to about 8, alternatively from about 5 independently to about 7, and further alternatively is about 7.

The coating material may include, but not necessarily be limited to, aluminosilicate, magnesium phosphate, aluminum phosphate, zirconium aluminum phosphate, zirconium phosphate, zirconium phosphonate, magnesium potassium phosphate, carbide materials such as tungsten carbide, polymer cements, high performance polymer coatings such as polyamide-imide and polyether ether ketones (PEEK), and combinations thereof. “High performance polymers” means that they have high temperature tolerance (more than 150° C.) and are chemically resistant. By “tolerance” is meant that the deformable particulate materials maintain their structural integrity, that is, they do not break down into smaller fragments up to at least this temperature, or when they contact chemicals up to at least this temperature. As noted, geopolymers are made by the reaction of an alkaline solution, including, but not necessarily limited to NaOH and/or KOH, and an aluminosilicate source by the application of low temperature (heating) through a sol-gel reaction. These inorganic polymers are considered “green” or environmentally advantageous, because they are synthesized from natural resources and their chemistry does not adversely affect the environment.

An alkaline solution is required to cause the geopolymerization reaction; this could be a monovalent alkali metal hydroxide including, but not necessarily limited to, potassium hydroxide, sodium hydroxide, and the like. If a divalent alkali metal hydroxide is used, the solubility will decrease, and some amount of a monovalent alkali metal hydroxide may be necessary or helpful in order to initiate the reaction.

In the specific, non-limiting case of forming the aluminosilicate coating, the mole ratio of SiO₂/Al₂O₃ ranges from about 1:1 independently to about 30:1; alternatively from about 1:1 independently to about 6:1. In one non-limiting embodiment, polymers such as, but not necessarily limited to, CMC (carboxymethyl cellulose), guar, guar derivatives, and the like may be included to improve the flexibility of the coating. In one non-limiting embodiment, these materials may be useful for flow back control, particularly in the embodiment where the coating may be deformable—this may help the proppant stay in place. These materials may be used together with non-coated proppants. It is expected that flowing fluid back through the coated proppants where the amount of the proppants flowed back is less than the amount of otherwise identical proppants flowed back, where the otherwise identical proppants have an absence of the coating described herein. In one non-limiting version, the amount of proppants flowed back is reduced from about 10 wt % or more less proppant produced to 100 wt %; alternatively, the amount of proppants flowed back is reduced from about 20 wt % or more less proppant produced to 80 wt %.

In another non-restrictive version, the mole ratio of SiO₂ to alkali metal hydroxide or alkali metal oxide (e.g. Na₂O or K₂O) ranges from about 0.1:1 independently to about 6:1; alternatively from about 0.67:1 independently to about 2:1. Suitable ratios include, but are not necessarily limited to about 1.3:1 and about 1.52:1; either of which may be suitable alternative lower or upper thresholds of a range.

A suitable temperature range to initiate the polymerization of the coating may range from about 20° C. independently to about 300° C.; alternatively from about 60° C. independently to about 200° C. Alternatively, 20° C. may be defined for all purposes herein as “room temperature”, which may also be understood to range from about 19° C. to about 26° C.

A suitable temperature range to further complete or cure the polymerization of the coating may range from about 20° C. independently to about 300° C.; alternatively from about 20° C. independently to about 200° C.

The amount of the coating, using the proppant (or proppant core) as a basis, ranges from about 2 wt % independently to about 30 wt % or higher; alternatively from about 5 wt % independently to about 15 wt %. Suitable amounts include, but are not necessarily limited to, about 2 wt %, about 4 wt %, about 5 wt %, about 8 wt %, and about 15 wt %, any of which may serve as a suitable lower or upper threshold of a proportion range.

It is expected that the coatings described herein may be applied to light weight proppants (LWP) in order to improve their strength while maintaining low apparent density. The coating will also increase the temperature tolerance of the polymer beads.

FIG. 1 illustrates a schematic, cross-sectional diagram of a coated proppant 10 as described herein, where the proppant core 12 is at least partially coated by a coating 14. It will be appreciated that “a coating at least partially covering the proppant cores” may be defined as the majority (over 50 wt %) of the proppants have at least some coating thereon even if 100 wt % of the proppants are not completely covered. Alternatively, “a coating at least partially covering the proppant cores” may be defined as at least the majority (over 50 wt %) of the proppants are completely covered with the coating. In another non-limiting embodiment, both of these definitions may be used simultaneously.

Stated another way, the thickness of the coating may range from about 2 independently to about 120 microns, alternatively from about 50 independently to about 80 microns, over a relatively wide range, in another non-limiting embodiment.

Additives, such as fillers, plasticizers, cure accelerators and retarders, and rheology modifiers may be used in the coating compositions described herein in order to achieve desired economical, physical, and chemical properties of the proppant coating during the mixing of the chemical components, forming and cure of the particles, and the field performance of the coatings on the proppants.

Compatible fillers include, but are not necessarily limited to, waste materials such as silica sand, Kevlar fibers, fly ash, sludges, slags, waste paper, rice husks, saw dust, and the like, volcanic aggregates, such as expanded perlite, pumice, scoria, obsidian, and the like, minerals, such as diatomaceous earth, mica, borosilicates, clays, metal oxides, metal fluorides, and the like, plant and animal remains, such as sea shells, coral, hemp fibers, and the like, manufactured fillers, such as silica, mineral fibers and mats, chopped or woven fiberglass, metal wools, turnings, shavings, wollastonite, nanoclays, carbon nanotubes, carbon fibers and nanofibers, graphene oxide, or graphite.

Shown in FIG. 2B is a microphotograph of white sand proppant as a control. Shown in FIG. 2A is the white sand proppant of FIG. 2B after having been coated with 5 wt % of an aluminosilicate coating as described herein.

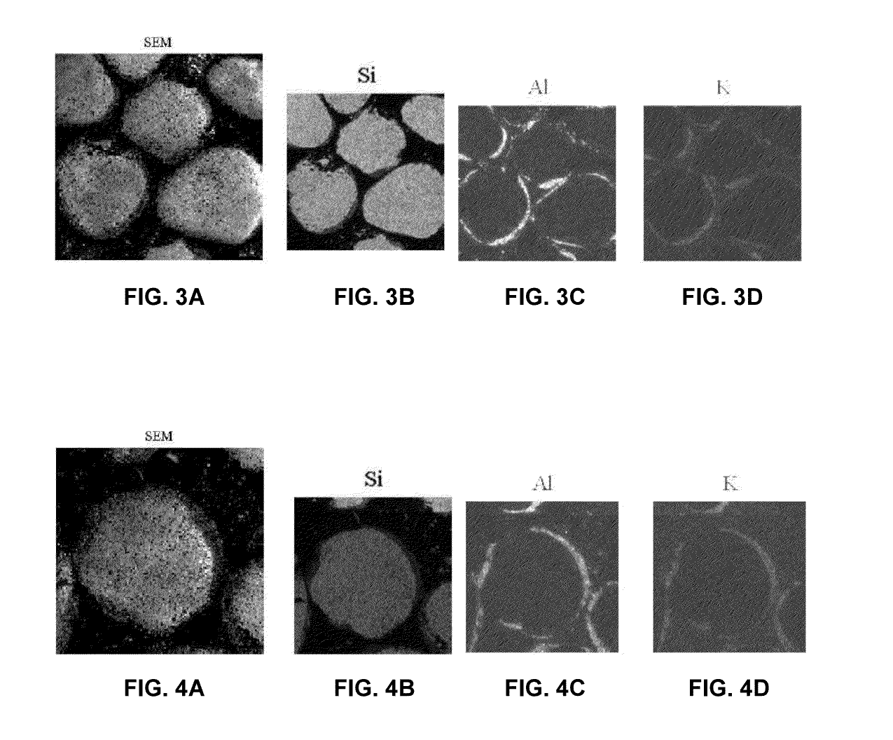

The coating on the white sand proppant was characterized by SEM (scanning electron microscopy) as shown in FIGS. 3A-4D. The micrographs (microphotographs) of FIGS. 3A-3D were taken at 50× magnification and FIGS. 4A-4D were taken at 80× magnification. FIGS. 3A and 4A were obtained from secondary electrons that produce SEM images. Since the coating is an aluminosilicate and the core is silica sand, there is no differentiation between the two materials through direct observation by SEM, the geopolymer coating cannot be seen directly from the SEM micrographs of FIGS. 3A and 4A. Backscatter electron (BSE) images can provide information about the distribution of different elements in the sample. Silicon, aluminum and potassium profiles of the coating are shown by the back scattering micrographs of FIGS. 3B and 4B, FIGS. 3C and 4C and FIGS. 3D and 4D, respectively. The SEM micrographs in FIGS. 3A and 4A show that the particles are homogeneous, FIGS. 3B and 4B, FIGS. 3C and 4C and FIGS. 3D and 4D show that the coating is evenly distributed around the surface of the core.

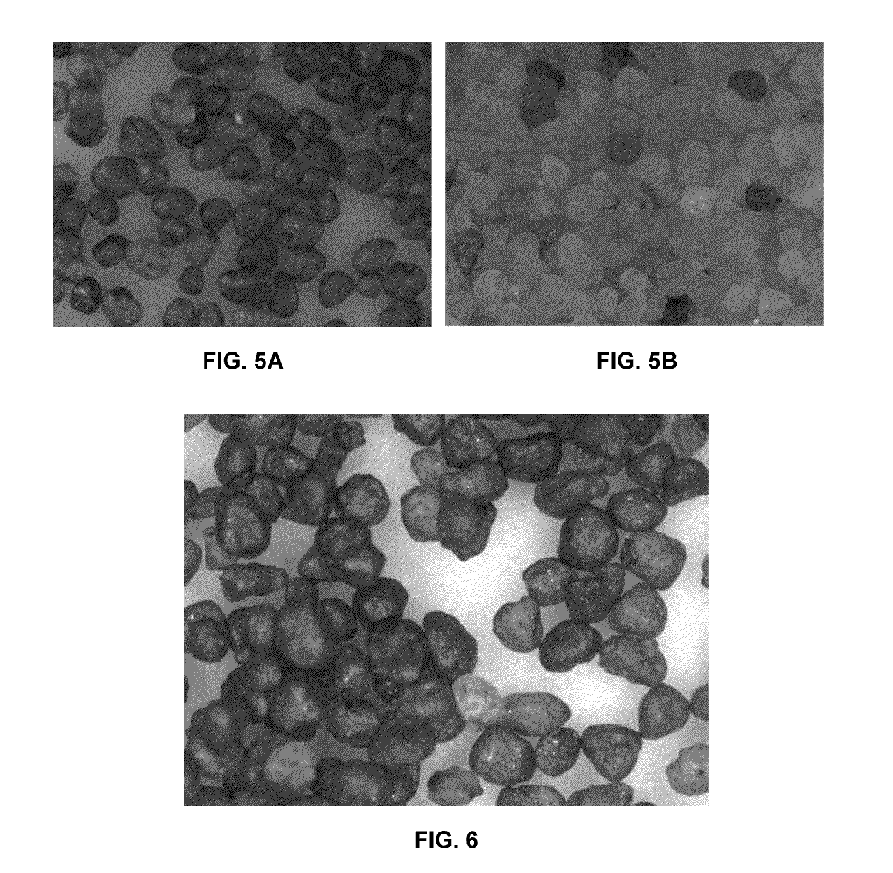

Shown in FIG. 5B is a micrograph of brown sand as a control proppant with no coating. This is contrasted with FIG. 5A which is a micrograph of brown sand, such as that seen in FIG. 5B, having an 8 wt % coating of aluminosilicate as described herein; which coated proppant is designated III-30.

Shown in FIG. 6 is a micrograph of brown sand having a 15 wt % aluminosilicate coating thereon, designated as III-31.

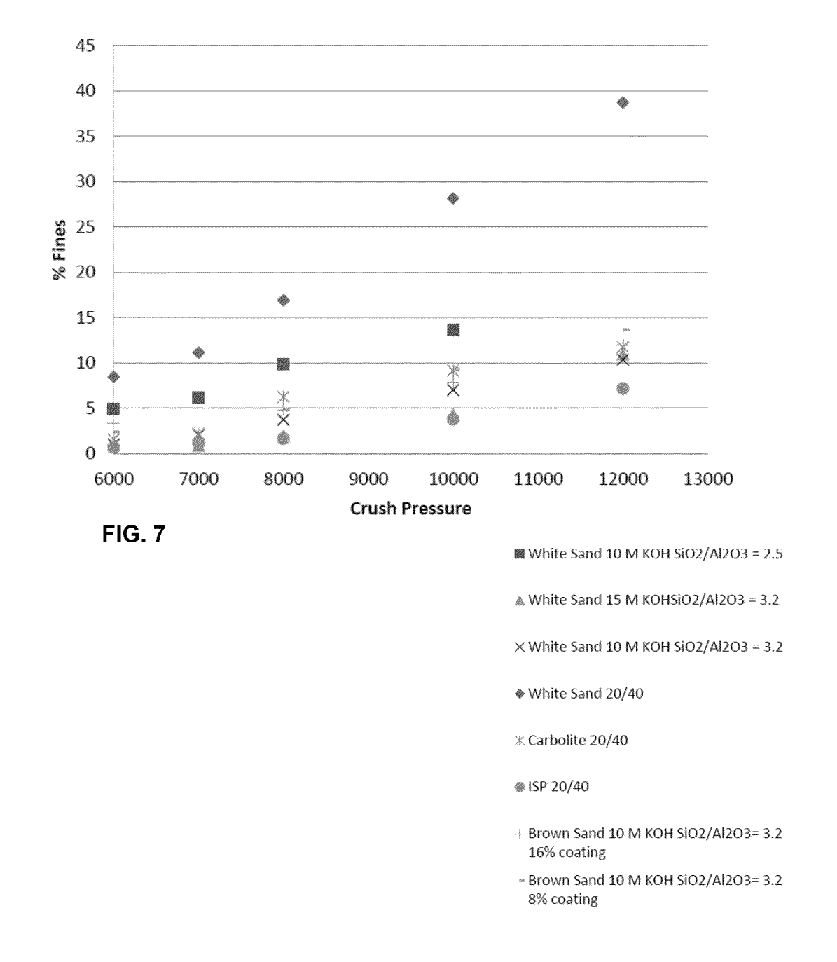

Shown in FIG. 7 is a graph illustrating the wt % generated fines as a function of closure stress of some geopolymer-coated sand compared to some conventional proppants. A more specific description of the various proppants of FIG. 7, in the order of the legend in FIG. 7 is as follows:
▪ White sand coated with a solution of 10 M potassium hydroxide (KOH) and SiO₂/Al₂O₃ at a molar ratio of 2.5:1.
▴ White sand coated with a solution of 15 M KOH and SiO₂/Al₂O₃ at a molar ratio of 3.2:1.
X White sand coated with a solution of 10 M KOH and SiO₂/Al₂O₃ at a molar ratio of 3.2:1.
♦ White sand 20/40 mesh (0.8/0.4 mm).
[symbol] CARBOLITE® 20/40 mesh (0.8/0.4 mm) proppant available from Carbo Ceramics.
ISP 20/40 mesh (0.8/0.4 mm) proppant available from Carbo Ceramics.
+ Brown sand coated with a solution of 10 M KOH and SiO₂/Al₂O₃ at a molar ratio of 3.2:1 with a 16 wt % coating.
— Brown sand coated with a solution of 10 M KOH and SiO₂/Al₂O₃ at a molar ratio of 3.2:1 with a 8 wt % coating.
   It may be seen from FIG. 7 that the coated proppants as described herein have reduced fines production compared to some commonly used commercial proppants.

It will be appreciated that the descriptions above with respect to particular embodiments above are not intended to limit the invention in any way, but which are simply to further highlight or illustrate the invention.

It is to be understood that the invention is not limited to the exact details of procedures, operation, exact materials, or embodiments shown and described, as modifications and equivalents will be apparent to one skilled in the art. Accordingly, the invention is therefore to be limited only by the spirit and scope of the appended claims. Further, the specification is to be regarded in an illustrative rather than a restrictive sense. For example, specific combinations of proppant cores, coatings, reactants to form the coatings and/or cores, reaction conditions to form coatings on the proppants, hydraulic fracturing method steps, and the like, falling within the claimed parameters, but not specifically identified or tried in a particular method, are anticipated to be within the scope of this invention.

The terms “comprises” and “comprising” in the claims should be interpreted to mean including, but not limited to, the recited elements.

The present invention may suitably comprise, consist or consist essentially of the elements disclosed and may be practiced in the absence of an element not disclosed. For instance, there may be provided coated proppants consisting essentially of or consisting of a plurality of proppant cores selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof, and a coating at least partially covering the proppant cores, where the coating is selected from the group consisting of aluminosilicate, magnesium phosphate, aluminum phosphate, zirconium aluminum phosphate, zirconium phosphate, zirconium phosphonate, magnesium potassium phosphate, carbide materials such as tungsten carbide, polymer cements, high performance polymer coatings such as polyamide-imide and polyether ether ketones (PEEK), and combinations thereof.

Further there may be provided a method of preparing a strengthened proppant consisting essentially of or consisting of mixing together an alkali metal hydroxide and an aluminosilicate binder in water to form an aqueous solution, coating a plurality of proppant cores with the aqueous solution, and heating the aqueous solution-coated proppant cores to polymerize the aluminosilicate in the aqueous solution.

There may also be provided coated proppants prepared by a method consisting essentially of or consisting of mixing together an alkali metal hydroxide and an aluminosilicate binder in water to form an aqueous solution, coating a plurality of proppant cores with the aqueous solution, and heating the aqueous solution-coated proppant cores to polymerize the aluminosilicate.

Additionally there may be provided a method for controlling fines production from a subterranean formation, which method consisting essentially of or consisting of placing at least one wellbore in the formation, hydraulically fracturing the formation via the wellbore via a fracturing fluid which creates at least one fracture, placing coated proppants into the fracture. The coated proppants comprise, consist essentially of or consist of a plurality of proppant cores as described in the previous paragraphs and a coating at least partially covering the proppant cores as described in the previous paragraphs.

What is claimed is:

1. Coated proppants comprising:
a plurality of proppant cores selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof; and
a coating at least partially covering the proppant cores, where the coating is selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof.

2. The coated proppants of claim 1 where the coating ranges from about 2 wt % to about 30 wt % of the proppant cores.

3. The coated proppants of claim 1 where the coated proppants have an apparent density between about 2.3 and 2.63 g/cm³.

4. The coated proppants of claim 1 where the coated proppants withstand a closing stress up to about 12,000 psi.

5. A method of preparing a strengthened proppant comprising:
mixing together an alkali metal hydroxide or an alkali metal oxide and an aluminosilicate binder in water to form an aqueous solution;
at least partially coating a plurality of proppant cores with the aqueous solution; and
heating the aqueous solution-coated proppant cores to polymerize the aluminosilicate.

6. The method of claim 5 where the aqueous solution has a mole ratio of SiO₂/Al₂O₃ ranging from about 1 to about 30.

7. The method of claim 5 where the ratio of silicate to alkali metal hydroxide or alkali metal oxide in the aqueous solution ranges from about 0.1:1 to about 6:1.

8. The method of claim 5 where the aqueous solution further comprises fillers selected from the group consisting of silica sand, Kevlar fibers, fly ash, sludges, slags, waste paper, rice husks, saw dust, volcanic aggregates, expanded perlite, pumice, scoria, obsidian, minerals, diatomaceous earth, mica, borosilicates, clays, metal oxides, metal fluorides, plant and animal remains, sea shells, coral, hemp fibers, manufactured fillers, silica, mineral fibers, mineral mats, chopped fiberglass, woven fiberglass, metal wools, turnings, shavings, wollastonite, nanoclays, carbon nanotubes, carbon fibers and nanofibers, graphene oxide, graphite, and combinations thereof.

9. The method of claim 5 where the proppant cores are heated prior to the coating with the aqueous solution.

10. The method of claim 9 where the heating is between about 20 and about 300° C.

11. The method of claim 5 where the proppant cores are selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof.

12. Coated proppants prepared by a method comprising:
mixing together an alkali metal hydroxide and an aluminosilicate binder in water to form an aqueous solution;
at least partially coating a plurality of proppant cores with the aqueous solution; and
heating the aqueous solution-coated proppant cores to polymerize the aluminosilicate.

13. The coated proppants of claim 12 where the aqueous solution has a mole ratio of SiO₂/Al₂O₃ ranging from about 1 to about 30.

14. The coated proppants of claim 12 where the ratio of silicate to alkali metal hydroxide or alkali metal oxide in the aqueous solution ranges from about 0.1:1 to about 6:1.

15. The coated proppants of claim 12 where the aqueous solution further comprises fillers selected from the group consisting of silica sand, Kevlar fibers, fly ash, sludges, slags, waste paper, rice husks, saw dust, volcanic aggregates, expanded perlite, pumice, scoria, obsidian, minerals, diatomaceous earth, mica, borosilicates, clays, metal oxides, metal fluorides, plant and animal remains, sea shells, coral, hemp fibers, manufactured fillers, silica, mineral fibers, mineral mats, chopped fiberglass, woven fiberglass, metal wools, turnings, shavings, wollastonite, nanoclays, carbon nanotubes, carbon fibers and nanofibers, graphene oxide, graphite, and combinations thereof.

16. The coated proppants of claim 12 where in the method the proppant cores are heated prior to the coating with the aqueous solution.

17. The coated proppants of claim 16 where the heating is between about 20 to about 300° C.

18. The coated proppants of claim 12 where the proppant cores are selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof.

19. A method for controlling fines production from a subterranean formation, which method comprises:
hydraulically fracturing a formation via a wellbore therethrough via a fracturing fluid which creates at least one fracture;
placing coated proppants into the fracture, where the coated proppants comprise:
a plurality of proppant cores selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof; and
a coating at least partially covering the proppant cores, where the coating is selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof, where the coating ranges from about 2 wt % to about 30 wt % of the proppant cores;
removing the fracturing fluid from the at least one fracture, where the closure stress of the fracture ranges from about 5000 to about 12,000 psi; and
producing a fluid from the formation where the fines obtained are lower than about 10 wt %.

20. A method of fracturing a subterranean formation, comprising:
injecting coated proppants into a hydraulic fracture created in the subterranean formation, the coated proppants comprising:
a plurality of proppant cores selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof; and
a coating at least partially covering the proppant cores, where the coating is selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings polyamide-imides, polyether ether ketones (PEEK), and combinations thereof; and
flowing fluid back through the coated proppants where the amount of the proppants flowed back is less than the amount of otherwise identical proppants flowed back, where the otherwise identical proppants have an absence of the coating.
